(19) United States
(12) Patent Application Publication
(10) Pub. No.: US 2006/0127530 A1
(43) Pub. Date: Jun. 15, 2006

(54) Avian feed

(76) Inventor: Glen S. Axelrod, Colts Neck, NJ (US)

Correspondence Address: Steven J. Grossman;Grossman, Tucker, Perreault & Pfleger, PLLC, 55 South Commercial Street, Manchester, NH, 03101, US

(21) Appl. No.: 11/009,397

(22) Filed: Dec. 10, 2004

(51) Int. Cl. A23K 1/18

(52) U.S. Cl. 426/2

(57) ABSTRACT

The present invention provides an attractive bird feed and a method of increasing the attractiveness of bird feed. The bird feed may be mixed with animal digests. Other components such as yeast may also be incorporated.

### FIELD OF INVENTION

The present invention is directed to bird feed. More particularly, it is directed to the addition of an attractant to bird feed which makes the bird feed more desirable to birds and/or mammals, and which may also increase the nutritional value of the feed to the animal.

### BACKGROUND

Increasing nutritional benefit, the attractiveness of feed and the presentation of feed for pet bird feeding and wild bird feeding is well known in the art. For example, there are a number of methods to attract birds, such as feeding different types of feed or utilizing different types of feeders. Modifications have also been made to the feed itself.

It is well known in the art to treat bird feed with a variety of specific substances. For example, treating bird feed with capsaicin, capsaicin derivatives and analogs thereof to prevent animals having capsaicin sensitive receptors, such as rodents, from consuming the bird seed is disclosed in U.S. Pat. No. 5,821,269. U.S. Pat. No. 6,009,663 discloses the use of a carrier matrix formed of an organic polymer or proteinaceous compound coated with seeds providing protection for the seeds as well as nutritional balance, reportedly aiding digestion and increasing product presentation and acceptability. U.S. Pat. No. 4,161,543 reports the addition of sodium diacetate to wild bird feeds. The sodium diacetate reportedly acts to attract animals and enhance the taste threshold.

Besides those mentioned above, a number of efforts have also been made to increase the attractiveness off bird feed by coating the bird feed with certain compounds. For example, U.S. Pat. No. 4,942,043 discloses the use of a sunflower heart or chip and a protective or hydrophobic top coat. The hydrophobic top coat contains corn gluten meal granules and lipids such as hydrogenated vegetable oil and tallow may also be included. Furthermore other agents, such as antioxidants, are contemplated to prevent degradation of the lipids. Bird feed has also been coated with vitamins and minerals.

While the above certainly contribute to the body of feed products available, there is nonetheless a need to improve on the above, particularly with respect to increasing the general attractiveness of bird feed to birds and/or mammals. Accordingly it is one object of the present invention to provide bird feed treated with an attractant to increase the attractiveness of the feed to birds and/or mammals.

### SUMMARY

An aspect of the present invention provides a feed comprising bird feed and a mixture of animal digests.

Another aspect of the present invention provides a method for increasing the attractiveness of bird feed comprising supplying bird feed; supplying animal digests; and combining the bird feed with the animal digests.

### DETAILED DESCRIPTION

The present invention relates to increasing the attractiveness of bird feed for birds and/or mammals. More particularly, the present invention relates to treating bird feed with a composition that contains an animal digest, e.g., hydrolyzed liver, preferably poultry liver, in combination optionally in combination with other ingredients. Bird feed is any food, as the case may be, that may be delivered to a bird and which is suitable for consumption by a bird.

Beginning with the feed component, the feed may comprise any number of acceptable foods for consumption by birds or mammals. These foods preferably include one or more of the following: seed, nuts, grit, grain, fruits, meats, and mixtures thereof. Preferably, the seed utilized in the present invention may include one or more of the following: sunflower, canary, niger thistle, safflower, rape, linseed, mawseed, tares, millet and mixtures thereof. More preferably, the sunflower seeds may be australian, black oil or black striped sunflower seeds or the sunflower seeds may be hulled. Also more preferably, the millet may include Japanese, white proso and red proso.

Preferably, the nuts utilized in the present invention include peanut, hazel nut, acorn, brazil nuts, pecans, pine nuts and mixtures there of. Also preferably, the grains utilized in the present invention include buckwheat, barley, corn, maize, wheat, oats, milo rice and mixtures thereof. More preferably, the milo may include grain sorghum or red sorghum. Also more preferably, the oats may be hulled, whole or crushed and the corn may include cracked corn. Grit may preferably be course or fine.

Fruits may include, but is not limited to, berries, dates, apples, peaches, papaya, mango, pineapple, bananas, melon, raisins, oranges, cherry, fruit seeds and jellies of fruit. Preferably, berries may consist of cranberries, blueberries, strawberries, black berries, currants, elderberries, black berries, holly berries, juniper berries and raspberries. Melons preferably may be selected from watermelons, honeydew melons and cantaloupe. More preferably, the fruit is a dried fruit. Meat may include insects, mealworm and other proteinacious foodstuff.

The attractant is preferably a mixture of animal digests. Other components, e.g. a yeast such as brewers yeast, may be included in the mixture. By animal digest it is meant to include a substance made by taking relatively clean and relatively undecomposed animal tissue and breaking it down utilizing chemical or enzymatic hydrolysis. Preferably, the animal digest is hydrolyzed liver, e.g., hydrolyzed poultry liver. In addition, preferably, the animal digests do not contain hair, horn, teeth, hooves or feathers, which may be present in unavoidable trace amounts. Preferably, the animal digests may be obtained from Applied Food Biotechnology Incorporated, O'Fallon, Mo., and sold under the trade name Optimizor®.

Preferably, the additional components, such as brewers yeast, may be in a powdered, flake or tablet form prior to addition to the animal digests. The brewers yeast, or saccharomyces cerevisiae, are believed rich in B-complex vitamins and other nutrients. The mixture may also include tocopherols which act as natural preservatives. Preferably the tocopherols are vitamins C and E. It is believed that the tocopherols function as antioxidants, stabilizing fats and oils. Rosemary may also be added to the mixture. It is believed that the rosemary also acts as a natural preservative functioning as an antioxidant to stabilize the fats and oils. Furthermore, lecithin may be added to the mixture and is believed to assist in the digestion of fat. In accordance with the above, preferably, the hydrolyzed liver may be present in an amount greater than about 50%, and preferably, at levels greater than 60%, and in a most preferred embodiment, may be present at a level of greater than 70%. In an even more preferred embodiment, the hydrolyzed liver may be present at levels of about 70-75%. In turn, the other components mixed with the animal digests include at least about 10-15% brewers yeast, and most preferably, about 25-30%. The remaining ingredients may then include about 0.01-1.0% lecithin, 0.01-1.0% tocopherols and 0.01-1.0% rosemary oils.

Preferably the mixture may be in dry or liquid form, and either form may be a concentrate. Most preferably, if the mixture is in dry form it may be either dispersed in fat or may be added to liquid digests. It should be appreciated that the feed may be treated with the attractant using a number of methods. For example, the feed may be coated with the attractant containing mixture or the attractant containing mixture may be dispersed in the feed in discreet particles. Furthermore, the feed may be impregnated with the attractant. It should also be appreciated that the attractant may be present between about 0.1-20% (wt.) and the bird feed may be present between about 80-99% in the feed component, and all incremental values therebetween.

The foregoing description is provided to illustrate and explain the present invention. However, the description hereinabove should not be considered to limit the scope of the invention set forth in the claims appended here to.

What is claimed is:

1. A feed comprising bird feed and animal digests.

2. The feed of claim 1 wherein said feed further comprises yeast.

3. The feed of claim 1 wherein said bird feed is selected from the group consisting of seed, nut, grit, grain, fruit, meat and mixtures thereof.

4. The feed of claim 1 wherein said animal digests are hydrolyzed liver.

5. The feed of claim 1 further comprising an antioxidant.

6. The feed of claim 1 further comprising rosemary oil.

7. The feed of claim 1 further comprising tocopherols.

8. The feed of claim 1 further comprising lecithin.

9. The feed of claim 1 wherein said animal digests are coated on the bird feed.

10. The feed of claim 1 wherein said animal digests are dispersed within the bird feed.

11. The feed of claim 1 wherein said animal digests are a liquid concentrate.

12. The feed of claim 1 wherein said animal digests are a dry concentrate.

13. The feed of claim 12 wherein said dry concentrate is dispersed in fat.

14. The feed of claim 12 wherein said animal digests are in liquid form and said dry concentrate is added to said liquid digests.

15. The feed of claim 1 wherein said animal digests are about 0.1-20% by weight and said bird feed is about 80-99% by weight.

16. The feed of claim 4 wherein said hydrolyzed liver is poultry liver.

17. A method for increasing the attractiveness of bird feed comprising supplying bird feed; supplying animal digests; and combining said bird feed with said digests.

18. The method of claim 17 wherein said feed further comprises yeast.

19. The method of claim 17 wherein said bird feed is selected from the group consisting of seed, nut, grit, grain, fruit, meat and mixtures thereof.

20. The method of claim 17 wherein said animal digests are hydrolyzed liver.
